(19) United States
(12) Patent Application Publication
(10) Pub. No.: US 2017/0344295 A1
(43) Pub. Date: Nov. 30, 2017

(54) SYSTEM AND METHOD FOR FAST SECURE DESTRUCTION OR ERASE OF DATA IN A NON-VOLATILE MEMORY

(71) Applicant: SanDisk Technologies LLC, Plano, TX (US)

(72) Inventors: Liron Sheffi, Hod Hasharon (IL); Yuval Kenan, R.D. Merom Galil (IL); Amir Shaharabany, Kochav Yair (IL); Yacov Duzly, Ra'anana (IL)

(73) Assignee: SanDisk Technologies LLC, Plano, TX (US)

(21) Appl. No.: 15/168,835

(22) Filed: May 31, 2016

(51) Int. Cl. G06F 3/06; G06F 21/62; G11C 16/16

(52) U.S. Cl. CPC G06F 3/0623; G11C 16/16; G06F 3/0652; G06F 3/0688; G06F 21/6209

(57) ABSTRACT

A system and method is disclosed for fast secure destruction or erasure of data in a non-volatile memory. The method may include identifying a fast erase condition, such as an unauthorized access attempt, and then applying a fast erase process to a predetermined number of blocks of the non-volatile memory. The fast erase process may be implemented by applying an erase voltage for less than a full duration needed to place the blocks in a full erase state, but sufficient to make any data in those blocks unreadable. The system may include a non-volatile memory having a plurality of blocks and a controller configured to sequentially apply the erase voltage to a predetermined portion of the blocks for less than a time needed to fully erase those blocks such that the controller may rapidly make data unreadable without taking the full time to completely erase those blocks.

### BACKGROUND

Storage systems, such as solid state drives (SSDs) including NAND flash memory, are commonly used in electronic systems ranging from consumer products to enterprise-level computer systems. The market for SSDs has increased and its acceptance for use by private enterprises or government agencies to store secure data is becoming more widespread. Storage systems that contain private or secure information may be target to unwanted intrusions by those trying to steal information. Portable storage devices may also contain private or secure information and are subject to the additional risk of theft. Some storage devices use encryption to protect data, however discarding of the encryption key may not be enough in some circumstances because an old block in the storage device may still contain a copy of the key and that key may be recoverable. Even if the owner of the data or device at risk discovers a problem before the data has been taken, there may not be time to prevent the loss of the data to an unauthorized party.

### BRIEF DESCRIPTION OF THE DRAWINGS

FIG. 1A is a block diagram of an example non-volatile memory system.

FIG. 1B is a block diagram illustrating an exemplary storage module.

FIG. 1C is a block diagram illustrating a hierarchical storage system.

FIG. 2A is a block diagram illustrating exemplary components of a controller of a non-volatile memory system.

FIG. 2B is a block diagram illustrating exemplary components of a non-volatile memory of a non-volatile memory storage system.

FIG. 3 illustrates an example physical memory organization of the non-volatile memory system of FIG. 1A.

FIG. 4 shows an expanded view of a portion of the physical memory of FIG. 3.

FIG. 5 illustrates an example of different cell voltage distributions for a cell in a block of non-volatile memory representing different states available in a cell.

FIG. 6 is an example of an erase voltage in the form of a series of erase pulses that may be applied to a block to erase cells in the blocks.

FIG. 7 is a flow diagram illustrating an embodiment of a method of applying a fast erase process to select blocks in a non-volatile memory.

FIG. 8 is a flow chart of a process that may be implemented after the first fast erase phase of FIG. 7 to go back and completely erase blocks partially erased in the process of FIG. 7

FIG. 9 is a flow diagram illustrating an alternative embodiment of the method of FIG. 7.

### DETAILED DESCRIPTION

A method and system are disclosed below for permitting fast destruction or erasure of all or part of the data in a memory device to prevent data from being accessed or copied. As described in greater detail below, the fast destruction of the data may be accomplished by applying, to the entire non-volatile memory or a predetermined portion of the memory, one or more erase pulses sufficient to make the data unreadable. The order of applying the erase pulses may be to apply to all blocks in the non-volatile memory or all targeted blocks, an erase voltage of less than an amount needed to completely erase any given block, but enough to make the data unreadable. The shorter time needed to make the data unreadable rather than the longer time needed completely erase the data, may provide a better safeguard to owners of proprietary data. The fast data destruction technique may be used to quickly render the data in all the blocks unusable as part of a longer term process of completely erasing the blocks on another pass of applying an erase voltage to the blocks, or may simply stop at the point where the data is unusable and where the blocks cannot be written to again without first completing the erase process. The unusability of the data may be quantified in terms of a bit error rate (BER) that is achieved with the fast data destruction technique of partially completing the erase process, where a predetermined partial erase state is achieved by a predetermined voltage being applied to all blocks of interest based on the type of non-volatile memory cell and previously determined partial erase level for the particular type of non-volatile memory.

According to one aspect, a method is disclosed for preventing unauthorized data access from non-volatile memory in a data storage system. The method may include detecting an unauthorized data access attempt at the data storage system. Responsive to detecting the unauthorized data access attempt, the data storage system may executing only a portion of an erase operation in each of a predetermined plurality of blocks, where the portion of the erase operation is sufficient to make previously programmed data unreadable but insufficient to reach a full erase state for each of the predetermined plurality of blocks.

According to another aspect of the invention, a data storage system is disclosed. The data storage system includes a non-volatile memory having a plurality of blocks and a controller in communication with the non-volatile memory. The controller may be configured to, in response to identifying a fast erase event, select a first block of the plurality of blocks for a fast erase procedure and apply an erase voltage to the first block only for a period of time less than a predetermined full erase time, where the predetermined full erase time comprises a time duration for applying the erase voltage to bring the first block to a full erase state. The controller may be further configured to, after applying the erase voltage to the first block only for the period of time, and while the first block is not in the full erase state, apply the erase voltage to a next block of the plurality of blocks for only the period of time.

In different implementations, the controller may be further configured to apply the erase voltage, for only the period of time, sequentially to each of a predetermined portion of the plurality of blocks. The predetermined plurality may be all or less than all of the plurality of blocks. Alternatively, the predetermined plurality of blocks may be blocks of a first type and blocks of a second type that differ from the blocks of the first type, and the controller may be further configured first apply the erase voltage for only the period of time less than the predetermined full erase time to blocks of the first type prior to applying the erase voltage less than the predetermined full erase time to any blocks of the second type.

In yet another aspect, a data storage system includes a non-volatile memory having a plurality of blocks and a controller in communication with the non-volatile memory. The controller may be configured to, in response to receiving a full erase command, apply an erase voltage to a block associated with the full erase command for a full erase duration prior to applying the erase voltage to a next block associated with the full erase command for the full erase duration, wherein the erase voltage applied for the full erase duration is sufficient to place the first block and next block associated with the full erase command in a full erase state. The controller may be further configured to, in response to receiving a fast erase command, apply the erase voltage to a block associated with the fast erase command for only a portion of the full erase duration prior to applying the erase voltage to a next block associated with the fast erase command, where the erase voltage applied for less than the full erase duration is insufficient to place the first block and the next block associate with the fast erase command in the full erase state.

As used herein, a full erase state is a state of a block in the non-volatile memory which allows new data to be written (also referred to as programmed) to the block. When a block is fully written (programmed), it must be fully erased prior to being written to with new data. An example of obtaining a full erase state for a block of NAND flash memory is provided herein, where a predetermined cell voltage level of a cell in a block is identified as the fully erased state for that cell, however other specific voltage states are contemplated.

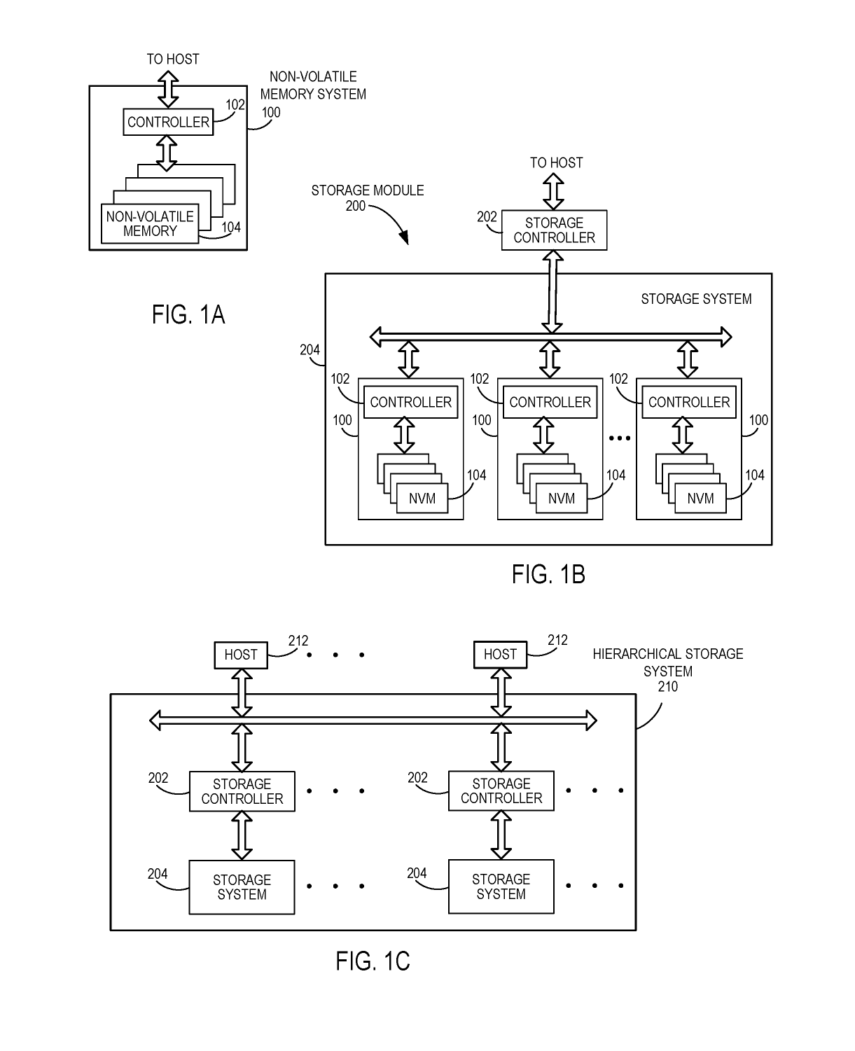

FIG. 1A is a block diagram illustrating a non-volatile memory system. The non-volatile memory (NVM) system 100 includes a controller 102 and non-volatile memory that may be made up of one or more non-volatile memory die 104. As used herein, the term die refers to the set of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a flash memory controller) can take the form of processing circuitry, one or more microprocessors or processors (also referred to herein as central processing units (CPUs)), and a computer-readable medium that stores computer-readable program code (e.g., software or firmware) executable by the (micro)processors, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host needs to read data from or write data to the flash memory, it will communicate with the flash memory controller. If the host provides a logical address to which data is to be read/written, the flash memory controller can convert the logical address received from the host to a physical address in the flash memory. The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, memory system 100 may be a card based system, such as a secure digital (SD) or a micro secure digital (micro-SD) card. In an alternate embodiment, memory system 100 may be part of an embedded memory system.

Although in the example illustrated in FIG. 1A NVM system 100 includes a single channel between controller 102 and non-volatile memory die 104, the subject matter described herein is not limited to having a single memory channel. For example, in some NAND memory system architectures, such as in FIGS. 1B and 1C, 2, 4, 8 or more NAND channels may exist between the controller and the NAND memory device, depending on controller capabilities. In any of the embodiments described herein, more than a single channel may exist between the controller and the memory die, even if a single channel is shown in the drawings.

FIG. 1B illustrates a storage module 200 that includes plural NVM systems 100. As such, storage module 200 may include a storage controller 202 that interfaces with a host and with storage system 204, which includes a plurality of NVM systems 100. The interface between storage controller 202 and NVM systems 100 may be a bus interface, such as a serial advanced technology attachment (SATA) or peripheral component interface express (PCIe) interface. Storage module 200, in one embodiment, may be a solid state drive (SSD), such as found in portable computing devices, such as laptop computers, and tablet computers.

FIG. 1C is a block diagram illustrating a hierarchical storage system. A hierarchical storage system 210 includes a plurality of storage controllers 202, each of which control a respective storage system 204. Host systems 212 may access memories within the hierarchical storage system via a bus interface. In one embodiment, the bus interface may be a non-volatile memory express (NVMe) or a fiber channel over Ethernet (FCoE) interface. In one embodiment, the system illustrated in FIG. 1C may be a rack mountable mass storage system that is accessible by multiple host computers, such as would be found in a data center or other location where mass storage is needed.

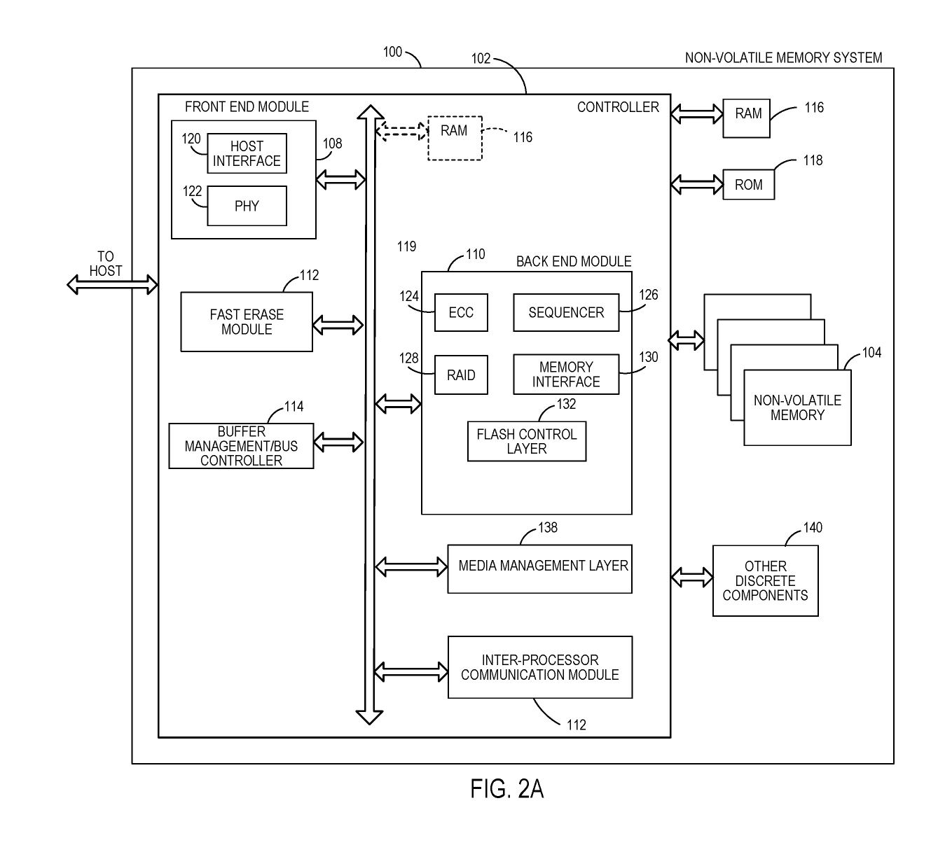

FIG. 2A is a block diagram illustrating exemplary components of controller 102 in more detail. Controller 102 includes a front end module 108 that interfaces with a host, a back end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Modules of the controller 102 may include fast erase module 112 present on the die of the controller 102. The fast erase module 112 may provide functionality for managing the use fast erasure procedures to prevent unauthorized access of data. A buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller 102. In yet other embodiments, portions of RAM 116 and ROM 118 may be located both within the controller 102 and outside the controller. Further, in some implementations, the controller 102, RAM 116, and ROM 118 may be located on separate semiconductor die. As described in greater detail below, the RAM 116 in the NVM system, whether outside the controller 102, inside the controller or present both outside and inside the controller 102, may contain a number of items, including a copy of all or part of the logical-to-physical mapping tables for the NVM system 100.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, SAS, Fibre Channel, USB, PCIe, and NVMe. The host interface 120 typically facilitates transfer for data, control signals, and timing signals.

Back end module 110 includes an error correction controller (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the NVM system 100. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

Additional components of NVM system 100 illustrated in FIG. 2A include the media management layer 138, which performs wear leveling of memory cells of non-volatile memory die 104 and manages mapping tables and logical-to-physical mapping or reading tasks. NVM system 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating exemplary components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two-dimensional and/or three-dimensional configuration. Peripheral circuitry 141 includes a state machine 152 that provides status information to controller 102. Non-volatile memory die 104 further includes a data cache 156 that caches data being read from or programmed into the non-volatile memory cells of the non-volatile memory array 142. The data cache 156 comprises sets of data latches 158 for each bit of data in a memory page of the non-volatile memory array 142. Thus, each set of data latches 158 may be a page in width and a plurality of sets of data latches 158 may be included in the data cache 156. For example, for a non-volatile memory array 142 arranged to store n bits per page, each set of data latches 158 may include N data latches where each data latch can store 1 bit of data.

In one implementation, an individual data latch may be a circuit that has two stable states and can store 1 bit of data, such as a set/reset, or SR, latch constructed from NAND gates. The data latches 158 may function as a type of volatile memory that only retains data while powered on. Any of a number of known types of data latch circuits may be used for the data latches in each set of data latches 158. Each non-volatile memory die 104 may have its own sets of data latches 158 and a non-volatile memory array 142. Peripheral circuitry 141 includes a state machine 152 that provides status information to controller 102. Peripheral circuitry 141 may also include additional input/output circuitry that may be used by the controller 102 to transfer data to and from the latches 158, as well as an array of sense modules operating in parallel to sense the current in each non-volatile memory cell of a page of memory cells in the non-volatile memory array 142. Each sense module may include a sense amplifier to detect whether a conduction current of a memory cell in communication with a respective sense module is above or below a reference level.

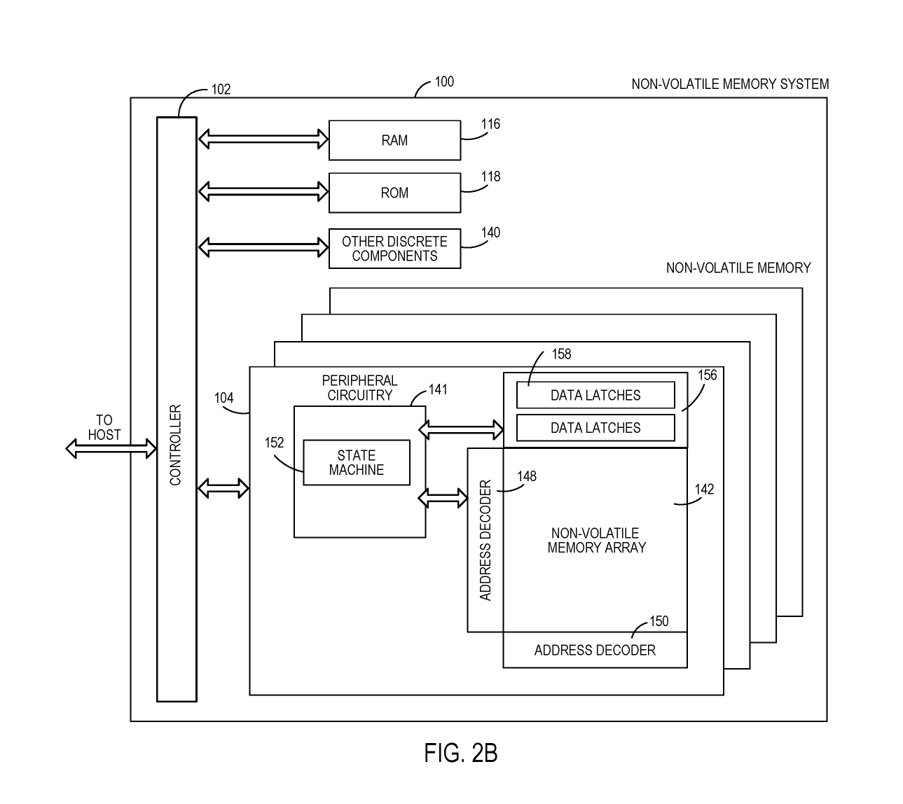

The non-volatile flash memory array 142 in the non-volatile memory 104 may be arranged in blocks of memory cells. A block of memory cells is the unit of erase, i.e., the smallest number of memory cells that are physically erasable together. For increased parallelism, however, the blocks may be operated in larger metablock units. One block from each of at least two planes of memory cells may be logically linked together to form a metablock. Referring to FIG. 3, a conceptual illustration of a representative flash memory cell array is shown. Four planes or sub-arrays 300, 302, 304 and 306 of memory cells may be on a single integrated memory cell chip, on two chips (two of the planes on each chip) or on four separate chips. The specific arrangement is not important to the discussion below and other numbers of planes may exist in a system. The planes are individually divided into blocks of memory cells shown in FIG. 3 by rectangles, such as blocks 308, 310, 312 and 314, located in respective planes 300, 302, 304 and 306. There may be dozens or hundreds of blocks in each plane. Blocks may be logically linked together to form a metablock that may be erased as a single unit. For example, blocks 308, 310, 312 and 314 may form a first metablock 316. The blocks used to form a metablock need not be restricted to the same relative locations within their respective planes, as is shown in the second metablock 318 made up of blocks 320, 322, 324 and 326.

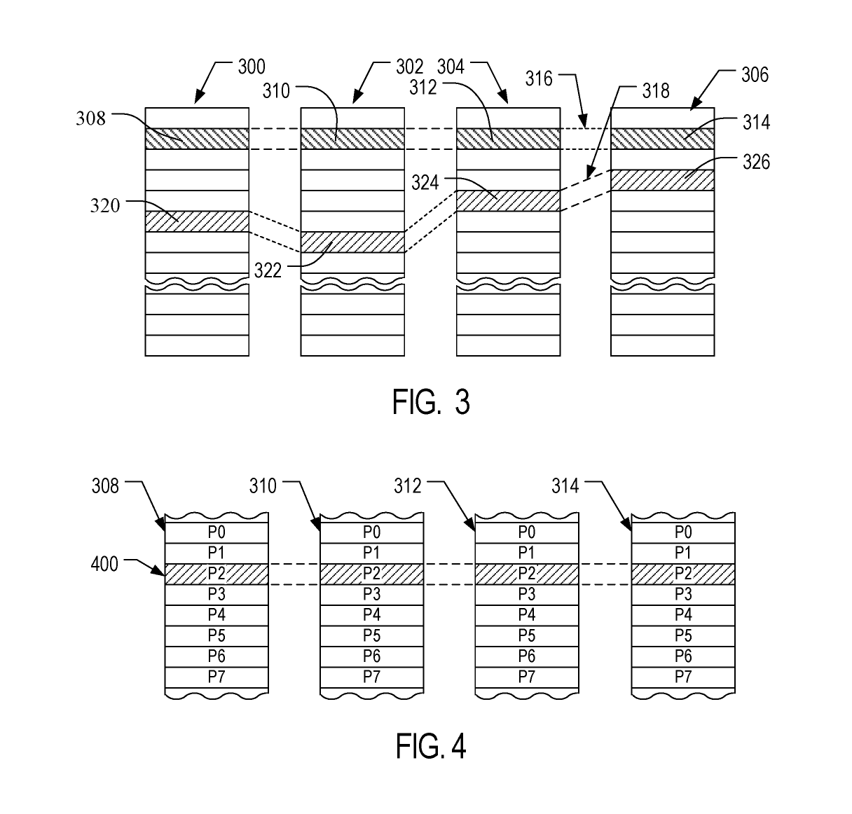

The individual blocks are in turn divided for operational purposes into pages of memory cells, as illustrated in FIG. 4. The memory cells of each of blocks 308, 310, 312 and 314, for example, are each divided into eight pages P0-P7. Alternately, there may be 16, 32 or more pages of memory cells within each block. A page is the unit of data programming within a block, containing the minimum amount of data that are programmed at one time. The minimum unit of data that can be read at one time may be less than a page. A metapage 400 is illustrated in FIG. 4 as formed of one physical page for each of the four blocks 308, 310, 312 and 314. The metapage 400 includes the page P2 in each of the four blocks but the pages of a metapage need not necessarily have the same relative position within each of the blocks. A metapage is typically the maximum unit of programming, although larger groupings may be programmed. The blocks disclosed in FIGS. 3-4 are referred to herein as physical blocks because they relate to groups of physical memory cells as discussed above. As used herein, a logical block is a virtual unit of address space defined to have the same size as a physical block. Each logical block may include a range of logical block addresses (LBAs) that are associated with data received from a host. The LBAs are then mapped to one or more physical blocks in the non-volatile memory system 100 where the data is physically stored.

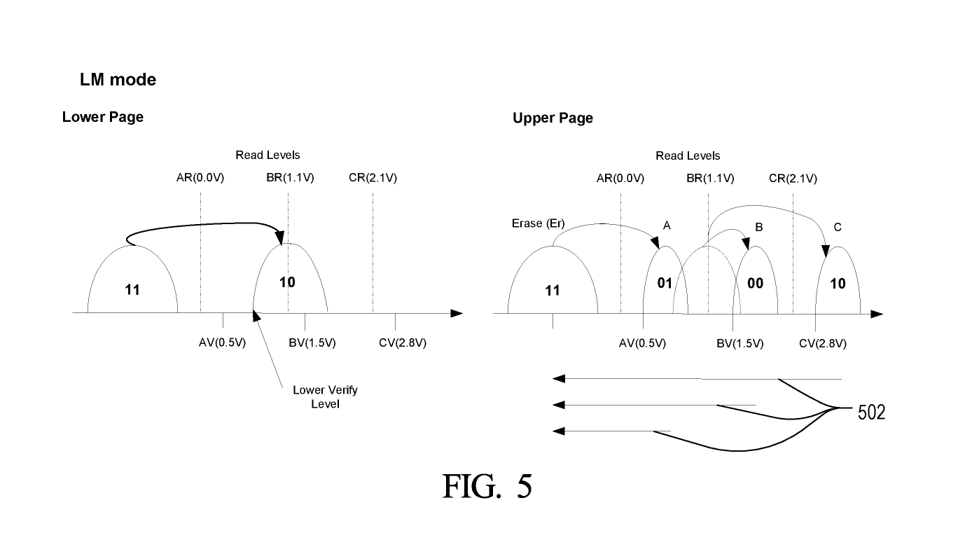

Referring to FIG. 5, a diagram illustrating charge levels in a cell of a block is shown. The charge storage elements of the memory cells in a block of memory are most commonly conductive floating gates but may alternatively be non-conductive dielectric charge trapping material. Each cell or memory unit may store a certain number of bits of data per cell. In FIG. 5, MLC memory may store four states and can retain two bits of data: 00 or 01 and 10 or 11. Alternatively, MLC memory may store eight states for retaining three bits of data. In other embodiments, there may be a different number of bits per cell.

The right side of FIG. 5 illustrates a memory cell that is operated to store two bits of data. This memory scheme may be referred to as eX2 memory because it has two bits per cell. Alternatively, the memory cells may be operated to store two levels of charge so that only a single bit of data is stored in each cell. This is typically referred to as a binary or single level cell (SLC) memory. SLC memory may store two states: 0 or 1. In FIG. 5, the cell may operate as a two-bit per cell memory scheme in which any of four states (Erase(Er), A, B, C) may exist or it may be operated with two states as SLC memory. The NAND circuitry may be configured for only a certain number of bit per cell MLC memory, but still operate as SLC. In other words, MLC memory can operate as a MLC or SLC memory.

In implementations of MLC memory operated to store two bits of data in each memory cell, each memory cell is configured to store four levels of charge corresponding to values of “11,” “01,” “10,” and “00,” corresponding to the Er, A, B and C states, respectively. Each bit of the two bits of data may represent a page bit of a lower page or a page bit of an upper page, where the lower page and upper page span across a series of memory cells sharing a common word line. Typically, the less significant bit of the two bits of data represents a page bit of a lower page and the more significant bit of the two bits of data represents a page bit of an upper page. The read margins are established for identifying each state. The three read margins (AR, BR, CR) delineate the four states. Likewise, there is a verify level (i.e. a voltage level) for establishing the lower bound (AV, BV, CV) for programming each state.

FIG. 5 is labeled as “LM mode” which may be referred to as lower at middle mode and will further be described below regarding the lower at middle or lower-middle intermediate state. The LM intermediate state may also be referred to as a lower page programmed stage. A value of “11” corresponds to an un-programmed state or erase state of the memory cell. When programming pulses are applied to the memory cell to program a page bit of the lower page, the level of charge is increased to represent a value of “10” corresponding to a programmed state of the page bit of the lower page. The lower page may be considered a logical concept that represents a location on a multi-level cell (MLC). If the MLC is two bits per cell, a logical page may include all the least significant bits of the cells on the wordline that are grouped together. In other words, the lower page contains the least significant bits. For a page bit of an upper page, when the page bit of the lower page is programmed (a value of “10”), programming pulses are applied to the memory cell for the page bit of the upper page to increase the level of charge to correspond to a value of “00” or “10” depending on the desired value of the page bit of the upper page. However, if the page bit of the lower page is not programmed such that the memory cell is in an un-programmed state (a value of “11”), applying programming pulses to the memory cell to program the page bit of the upper page increases the level of charge to represent a value of “01” corresponding to a programmed state of the page bit of the upper page.

In contrast, during an erase operation in SLC or MLC NAND flash memory, memory cells are returned to the erased state (a value of “11”). An erase operation may be implemented by the controller of the NVM system as a series of voltage pulses applied to the memory cells being erased. As shown by arrows 502, as each erase pulse is applied, the higher states (States A, B and C in FIG. 5) are gradually pushed down to the erase state (Er), where each cell voltage distribution falling below a threshold voltage (in the example of FIG. 5, below 0V) corresponds to an erased state. In some implementations, the erase state (Er) for a cell may be assumed to be reached after a predetermined number of erase pulses have been applied, or after an erase voltage has been applied for a predetermined period of time. In other implementations, the status of the cells may be verified by applying an erase verify voltage to confirm that the cells have indeed been erased.

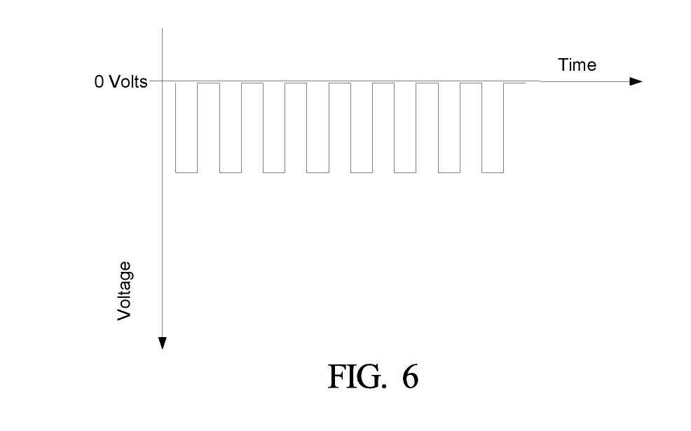

FIG. 6 illustrates one example set of erase pulses that may be applied to a cell to fully erase the cell where the amplitude and duration of each pulse is the same. In alternative implementations, the set of erase pulses may have a progressively increasing negative voltage amplitude over the immediate prior pulse, but equal duration pulses. Although a full erase operation that brings down a particular voltage distribution of a cell to the erase state (Er) may include a predetermined number of voltage pulses 502 that are applied in an equal duration pulse step pattern, the controller may be configured to provide erase pulses of different duration (for example, by setting one or more registers 106) or configured to manipulate one or more other erase parameters to use in generating one or more of the erase pulses.

Examples of these other parameters may include a starting pulse voltage, an amplitude increment between pulses, a pulse width, the time between pulses, and total duration of pulses. The erase parameters may be stored in registers inside the NVM system 100. In some implementations, erase parameters may be defined separately for each pulse or series of pulses. A full erase operation, based on one or more of the number of pulses, the pulse amplitude, and or other parameters, alone or in combination, may be predetermined based on the manufacturer of the non-volatile memory. Also, what is considered to be a full erase operation may be a predetermined number of erase voltage pulses of a fixed amplitude and pulse width, or some other predetermined set of parameters. Alternatively, an erase verify voltage may be applied to test whether a full erase state has been reached. The testing for the full erase state may take place at one or more different times during the erase operations in those implementations where checking whether the full erase state has been reached is included in the erase process.

Any of a number of combinations of pulse widths and erase pulse magnitudes may be implemented depending on the physical characteristics of the particular non-volatile memory. In some implementations, the pulse width for an individual erase pulse may be on the order of 0.5 to 1.0 milliseconds (msec.) and the duration of the erase-verify operation may be on the order of 100-200 microseconds (μsec.). Consequently, the total time required to perform a block erase operation may be on the order of 2.5 to 10 msec. (for example, with an application of 5 to 20 erase pulses). Assuming that a full erase operation that places the cells of a typical block in the full erase state (Er) takes 5 msec., then the initial phase of the fast erase operation described below may consist of applying a portion of that full erase duration, such as 50% of the time or the number of erase pulses known to fully erase a block, so that any data is unreadable in those blocks, but more blocks can be partially erased faster than the typical process of fully erasing a block before erasing a next block.

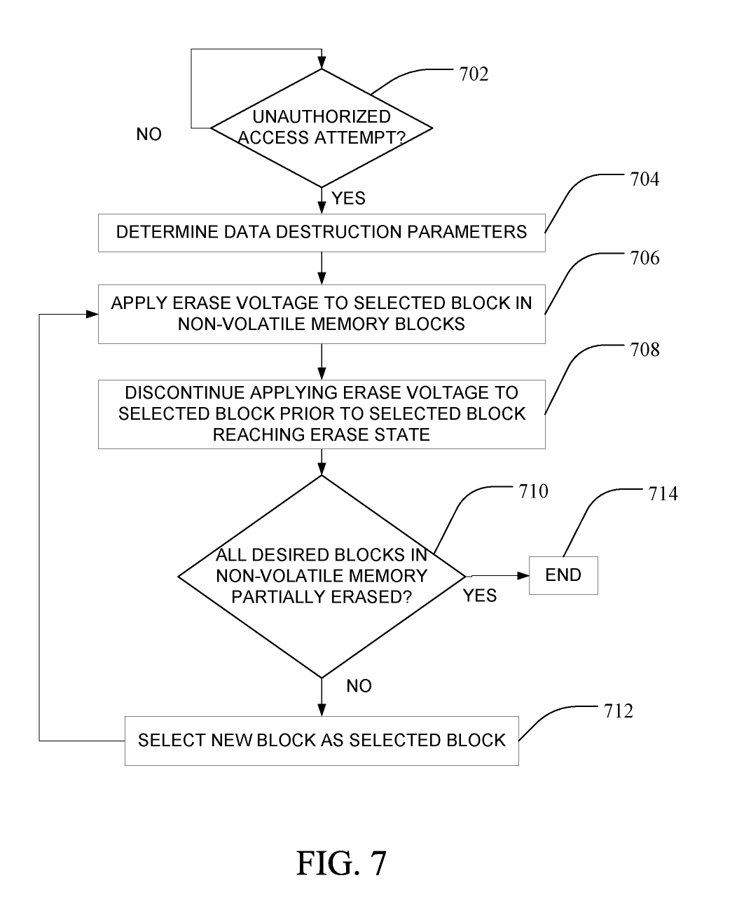

Referring now to FIG. 7, when a fast erase operation is desired, in one implementation the order of a standard erase operation may be altered from that typical of erase operations. In a typical erase operation, each block is fully erased prior to moving on to a next designated block such that each cell in the block is left at a voltage level that is recognized by the NVM system as the fully erased state. In contrast, in the fast erase procedure disclosed herein, only an abbreviated number of the erase pulses normally applied to fully erase each block are applied before moving on to a next block. Thus, each block is partially erased and left in the partially erased condition as the process is then applied to the next block. The fast erase module 112 only applies a portion of the typical erase voltage, either by way of reduced time duration, erase voltage level or other erase parameter that is needed to fully erase a block. In this abbreviated erase operation, the full erase state (e.g., Er) in a cell is purposely not reached such that the erase operation is stopped prior to reaching the Er state in memory cells of a given block so that a similar partial erase operation may then be initiated for a next block. Data in the partially erased block is unreadable because, although only partially erased, the bit error rate is too high to decipher or correct the data. Also, the block cannot be written to until a later full erase is achieved. However, by only erasing a block for a portion of the time needed for a full erase before moving on to the next block, the data in the NVM system may be rapidly put in an unreadable condition to prevent unauthorized access.

The process of applying this fast erase technique may begin when an unauthorized data access attempt is detected (at 702). The unauthorized data access attempt may be detected based on any number of criteria and the detection may be initiated by a host system connected to the NVM system, or by the NVM system itself. For example, the host or the NVM system may note that a maximum number of authentication attempts to all or part of the data has been exceeded and automatically initiate a data destruction operation for all or a part of the data as noted above. The data rate at which data is being accessed, the frequency of access or time of access, or any of a number of other criteria alone or in combination may also be predetermined to be the trigger for detecting unauthorized access. The fast erase command in response to the detected trigger may be received from the host or a remote system at the NVM system, or it may be generated within the NVM system itself depending on where the unauthorized access was first detected. In different implementations, the NVM system may detect the trigger, the host may detect the trigger, or both the NVM system and host may be configured to detect the trigger (e.g. a data access rate faster than a predetermined threshold).

Upon detecting the unauthorized access, and receiving the fast erase command, the NVM system 100 may retrieve the parameters appropriate for the abridged erase procedure (at 704). The parameters may be the number of erase pulses and duration, or the erase voltage level, or both. The erase parameters may be stored in a control data block in non-volatile memory or in other locations, and they may be overwritten with modified parameters in some embodiments. The command may be a general fast erase command where each blocks is only partially erased to impair or destroy the readability of data before stopping the erase procedure for that block and proceeding with partially erasing the next blocks. The fast erase module 112 via the controller 102 will apply the erase voltage to the cells of a currently selected block once as soon as the fast erase command is received (at 706). Prior to the selected block reaching the erase state, application of the erase voltage is discontinued for the currently selected block (at 708). The cessation of applying the erase voltage may be based on a fixed time period, a fixed number of erase pulses, or other predetermined criteria for leaving any data in the cells of the selected block in an unusable or unreadable state that is not a fully erased state. If other blocks are desired to be processed in the fast erase operation, the next one of the blocks is selected and the application of an erase voltage for less than a predetermined full erase duration is repeated for that block and all remaining ones of the desired blocks (at 710, 712). If no other desired blocks remain, the process may end (at 714).

In one implementation, the fast erase command is a general command that causes all blocks to be subjected to the fast erase process described. In other implementations, the command may trigger partial erasure of only a predetermined partition in the memory, or only of the blocks in the NVM system having the directory information or file system structures needed to find data in the NVM system. In yet other implementations, a first type of blocks, for example all those in a predetermined partition or containing directory information (such as boot blocks, directory blocks and/or other directory file information), file system structures or other key information types may be partially erased first prior to proceeding with erasure of a second type of blocks) such as user data, which may another limited portion, or the entirety of the remaining portion, of the blocks in the NVM system to a point that is less than a full erase, but sufficient to make the data unreadable.

Although the partial erasure achieved in the desired blocks via the initial fast erase procedure of FIG. 7 may be the stopping point of the fast erase process, in other embodiments, an erase completion process may immediately start up after the desired blocks have all been subjected to the first phase of the fast erase process described in FIG. 7. In other words, once the fast erase process of FIG. 7 has achieved rapid unreadability or destruction of the ability to access the data in the desired blocks, the process can continue until the full erase state (Er) is achieved in the cells of the desired blocks.

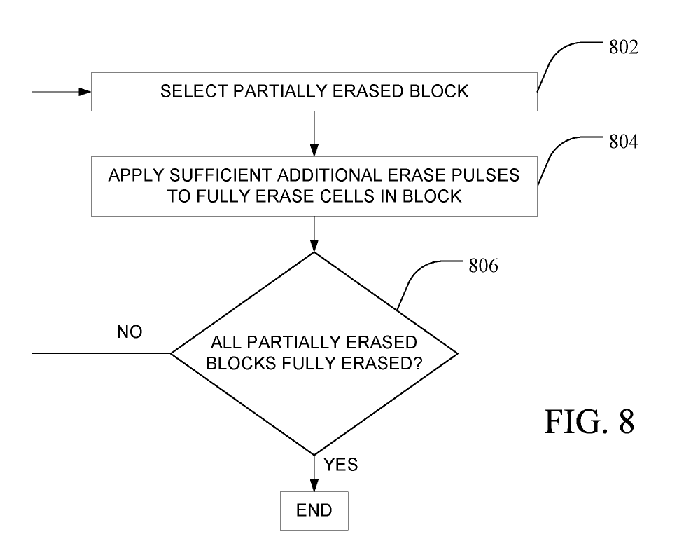

Referring to FIG. 8, rather than leaving the blocks in a partial state where, while the data is unusable the blocks are also not writable, the erase process may then be completed by revisiting the partially erased blocks and applying further erase pulses until the full erase state is reached. Thus, instead of ending at step 714 of FIG. 7, FIG. 8 represents further erase activity that replaces the end step 714. Specifically, once all the desired blocks have been partially erased (at 710, FIG. 7), the fast erase process may include an erase completion phase where the fast erase module 112 directs the controller 102 to revisit a first of the partially erased blocks (at 802), apply sufficient erase pulses to completely erase that block (at 804), and if other partially erased blocks are present from the initial fast erase process then the process is repeated with each remaining one of those blocks until all partially erased blocks are fully erased (at 806).

As noted previously, the fast erase parameters that the fast erase of FIG. 7 use to make the data unusable, but without fully erasing the cells of the block, may include one or more of the number of erase pulses of a fixed erase voltage that is less than the number known to be needed to reach the erase state, the voltage level of the erase pulses or other erase parameters. In one implementation, the reduced erase pulse count, erase time, erase voltage and/or other erase parameter may be applied without measuring the actual voltage state of the selected cell so that the fast erase process may be as fast as possible. However, in other implementations the process may include checking the actual state of the cells after applying the partial erase voltage pulses rather than relying solely on a predetermined number of erase pulses. In this alternative implementation, a measurement of the state of the block or cell in a block may be made one or more times during the application of the fast erase process. The measurement may be of a bit error rate (BER) in the block, a current voltage state of the block, or other metric that translates into whether the data in the block is sufficiently unreadable.

For example, in one implementation the desired BER to make the data unusable may a bit error rate of greater than the ability of the error correction code (ECC) engine 124 to correct for. Depending on the strength of the particular ECC used in a NVM system 100, this may be equivalent to a BER of 1.5%. The BER goal may be set at 5% or some other amount that is greater than the highest correctable BER for the particular device. The BER calculation may be an estimation using any of a number of known BER calculation techniques. For example, one version of estimating BER for a block may be to utilize parity errors found when reading pages of a block that are detected in the decoding process of reading that block. If a parity byte is added to a predetermined number of data bytes when data is written to the NVM system, then a checksum operation may be performed when the data is read. When decoding the data, the sum of checksum failures (the number of parity bytes that do not match the original checksum that was calculated when the data was written) on a predetermined percentage of pages of a block may be used during the partial erase operation to estimate the BER. When the checksum results for the selected portion of pages in a block show that the number of parity errors has reached the predetermined amount that may be used to estimate the bit error rate. Although the checksum errors for all the pages of the block being partially erased may be used, in one implementation only portion of the pages of a block may be sampled to obtain a representative BER for the block. Any of a number of other checksum techniques or other bit error rate calculation techniques may be used as well in implementations where the NVM system measures the state of cells in a block to verify that the partial erase has reached a desired BER during the partial erase process.

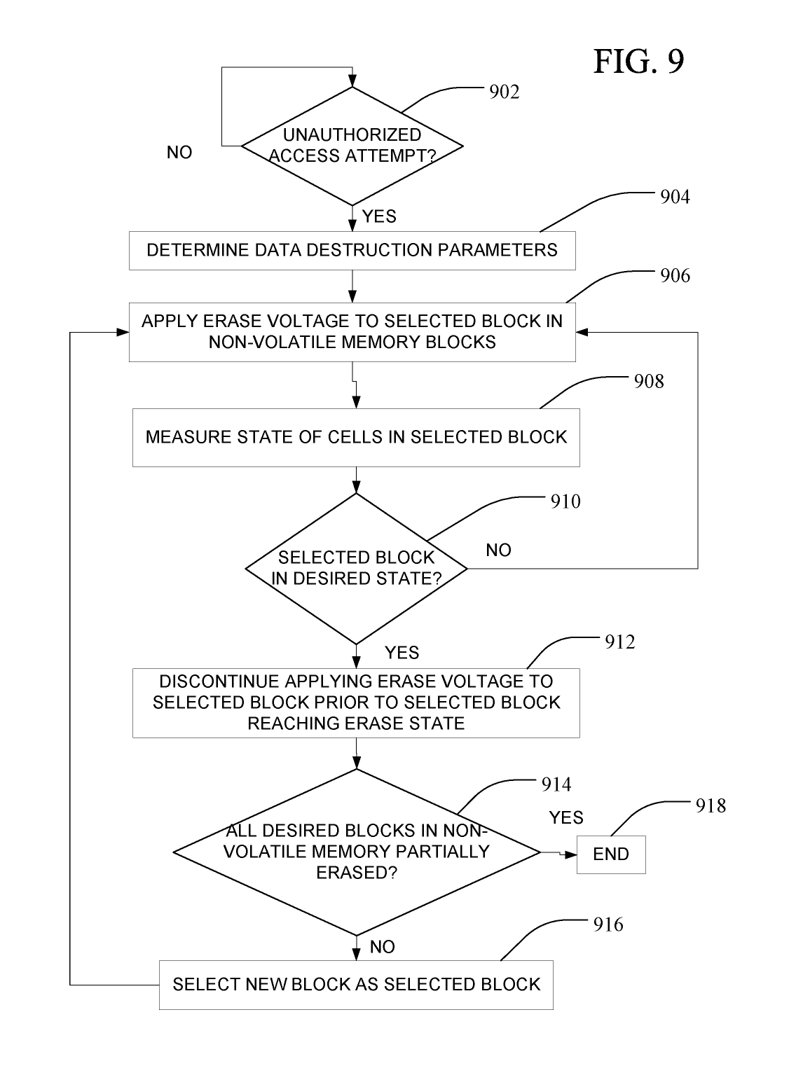

Referring to FIG. 9, implementations that incorporate measuring the state of cells in a block may include many of the same steps as provided in FIG. 7, with the addition of the measurement of the block to determine if the block has reached the state where the data in unreadable. When an unauthorized access is detected (at 902), the fast erase command is generated and the fast erase parameters for destruction of the data may be determined or retrieved (at 904). The erase voltage, in whatever form or duration, may be applied to a first selected block of a desired portion of blocks (at 906) and at least one measurement of the voltage or bit error rate of cells in the selected block may be made by the controller 102 to determine the state of the cells in the block (at 908). If the block is in the desired state, whether based on an estimated BER, actual voltage or other parameter that indicates data is unreadable, then the controller will discontinue application of the erase voltage prior to the block reaching the fully erased state (at 910, 912). Otherwise the erase voltage, or voltage pulses, will continue until the desired state is reached, but prior to the full erase state. The step of checking the actual (or estimated) BER or voltage of the block may be done repeatedly for a block until the desired BER or voltage is reached and the frequency of checking the BER or voltage for a block may be measured in increments of a fixed time duration or number of erase pulses in some implementations.

Although adding the steps of checking the BER of a block may be slower than simply choosing a number of erase pulses or duration to achieve an expected BER, the addition of the BER checking step may still be feasible. If, for example, the full erase time of a block is approximately 5 msec. and the time for checking BER is on the order of 100 microseconds (for example 80 microseconds to sense the block+10 microseconds to transfer the sensed data out+10 microseconds to then perform the BER calculation) the percentage of time spent checking the BER is still relatively small compared to a partial erase time of, for example, 2.5 milliseconds. The preceding examples of full erase times, lesser durations for the partial erase of the fast erase process, and times for checking BER are provided by way of example and the actual times for these steps may vary depending on the type of blocks and manufacturing processes used for a particular NVM system 100.

Additional desired blocks are selected for the fast erase process until all the desired blocks of the blocks in NVM system have been partially erased (at 914, 916). The fast erase process may end then (at 918) or, as described in FIG. 8, an erase completion phase may then be initiated to finish erasure of all of the partially erased blocks. As with the earlier implementations disclosed, the desired blocks may be a predetermined portion of, or all of, the blocks in the NVM system. Alternatively, the predetermined portion may be a first portion of blocks of a first type (e.g. directory blocks) that are processed through the fast erase procedure first, followed by a blocks of a second type (e.g. general data containing blocks that are indexed by the directory blocks).

In the present application, semiconductor memory devices such as those described in the present application may include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two-dimensional memory structure or a three-dimensional memory structure.

In a two dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three-dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two-dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two-dimensional and three-dimensional exemplary structures described but cover all relevant memory structures within the spirit and scope of the invention as described herein and as understood by one of skill in the art.

Methods and systems have been disclosed for implementing a fast erase process where each of a desired portion of blocks in a NVM memory system are partially erased, and not fully erased, before partially erasing a next block of the desired portion of blocks. The speed at which the data is made inaccessible via the partial erase, as compared to a full erase where more time is needed to allow cells to reach a full erase state, may help prevent unauthorized access to data. The fast erase module may cause the controller to apply an erase voltage for a portion of the time that is necessary to fully erase cells in a block, such that the cells are not in the erase voltage state but are in a state where any data is unreadable and essentially destroyed. The erase voltage and full erase time may be predetermined quantities that are used without taking the time to verify the current voltage state of the cells in a block, and/or may be verified by measuring resulting voltage or bit error rate at one or more times during application of the erase voltage. The fast erase process may also include applying the partial erase process to each block and moving on to the next block to partially erase that next block before completely erasing the prior block. Thus, the desired portion of blocks may all be partially erased in a rapid manner before optionally returning to complete the full erase of any of the blocks desired portion.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

We claim:

1. A method for preventing unauthorized data access from non-volatile memory in a data storage system, the method comprising:
detecting an unauthorized data access attempt at the data storage system;
in response to detecting the unauthorized data access attempt, executing only a portion of an erase operation in each of a predetermined plurality of blocks, and wherein the portion of the erase operation is sufficient to make previously programmed data unreadable but insufficient to reach a full erase state for each of the predetermined plurality of blocks.

2. The method of claim 1, wherein executing the portion of the erase operation comprises applying an erase voltage for less than a full erase duration to each of the predetermined plurality of blocks, wherein the full erase duration comprises an amount of time necessary for a block of the data storage system to reach the full erase state.

3. The method of claim 2, wherein applying the erase voltage comprises applying the erase voltage to each of the predetermined plurality of blocks sequentially.

4. The method of claim 1, wherein the predetermined plurality of blocks comprises all blocks in the non-volatile memory of the data storage system.

5. The method of claim 1, wherein executing the portion of the erase operation comprises applying an erase voltage until a predetermined bit error rate (BER) is achieved in each of the predetermined plurality of blocks.

6. The method of claim 1, wherein executing the portion of the erase operation comprises applying an erase voltage to each of the predetermined plurality of blocks until each of the predetermined plurality of blocks is at an intermediate target voltage that is different than a voltage corresponding to the full erase state.

7. The method of claim 1, wherein the predetermined plurality of blocks comprises blocks of a first type and blocks of a second type that differ from the blocks of the first type, and wherein executing the portion of the erase operation comprises first executing the portion of the erase operation on blocks of the first type prior to executing the portion of the erase operation on any blocks of the second type.

8. The method of claim 7, wherein the blocks of the first type comprise blocks containing boot data or directory data for the non-volatile memory and the blocks of the second type comprise blocks containing user data.

9. The method of claim 3, further comprising after executing only the portion of the erase operation for all of the predetermined portion of blocks, repeating application of the erase voltage to all of the predetermined portion of blocks until all of the predetermined portion of blocks reach the full erase state.

10. The method of claim 1, wherein executing the portion of the erase operation comprises:
applying an erase voltage to one of the predetermined plurality of blocks for less than a full erase duration, wherein the full erase duration comprises an amount of time necessary to reach the final erase state;
measuring a bit error rate (BER) of the one of the predetermined plurality of blocks; and
repeating the applying of the erase voltage for less than the full erase duration when the measured BER is less than a threshold BER.

11. The method of claim 1, wherein executing the portion of the erase operation comprises:
applying an erase voltage to one of the predetermined plurality of blocks for less than a full erase duration, wherein the full erase duration comprises an amount of time necessary to reach the final erase state;
measuring a voltage of the one of the predetermined plurality of blocks; and
repeating the applying of the erase voltage for less than the full erase duration when the measured voltage is less than a predetermined voltage target and wherein the predetermined voltage target differs from a voltage associated with the full erase state.

12. A data storage system comprising:
non-volatile memory having a plurality of blocks; and
a controller in communication with the non-volatile memory, the controller configured to:
in response to identifying a fast erase event, select a first block of the plurality of blocks for a fast erase procedure;
apply an erase voltage to the first block only for a period of time less than a predetermined full erase time, wherein the predetermined full erase time comprises a time duration for applying the erase voltage to bring the first block to a full erase state; and
after applying the erase voltage to the first block only for the period of time, and while the first block is not in the full erase state, apply the erase voltage to a next block of the plurality of blocks for only the period of time.

13. The data storage system of claim 12, wherein the controller is further configured to apply the erase voltage, for only the period of time, sequentially to each of a predetermined portion of the plurality of blocks that is less than all of the plurality of blocks.

14. The data storage system of claim 13, wherein the predetermined plurality of blocks comprises blocks of a first type and blocks of a second type that differ from the blocks of the first type, and wherein the controller is configured to first apply the erase voltage for only the period of time less than the predetermined full erase time to blocks of the first type prior to applying the erase voltage less than the predetermined full erase time to any blocks of the second type.

15. The data storage system of claim 14, wherein the blocks of the first type comprise blocks containing boot data or directory data for the non-volatile memory and the blocks of the second type comprise blocks containing user data.

16. The data storage system of claim 12, wherein the controller is further configured to, after applying the erase voltage to each of the plurality of blocks for only the period of time less than the predetermined full erase time, repeat application of the erase voltage to all of the plurality of blocks until all of the plurality of blocks reach the full erase state.

17. The data storage system of claim 12, wherein to apply the erase voltage to the first block only for the period of time, the controller is configured to:
apply the erase voltage to the first block for a first period of time less than the predetermined full erase time;
measure a bit error rate (BER) of the first block; and
repeat the applying of the erase voltage for a second period of time less than the predetermined full erase time when the measured BER is less than a threshold BER, wherein a sum of the first and the second periods of time is less than the predetermined full erase time.

18. A data storage system comprising:
non-volatile memory having a plurality of blocks; and
a controller in communication with the non-volatile memory, the controller configured to:
in response to receiving a full erase command, apply an erase voltage to a block associated with the full erase command for a full erase duration prior to applying the erase voltage to a next block associated with the full erase command for the full erase duration, wherein the erase voltage applied for the full erase duration is sufficient to place the first block and next block associated with the full erase command in a full erase state; and
in response to receiving a fast erase command, apply the erase voltage to a block associated with the fast erase command for only a portion of the full erase duration prior to applying the erase voltage to a next block associated with the fast erase command, where the erase voltage applied for less than the full erase duration is insufficient to place the first block and the next block associate with the fast erase command in the full erase state.

19. The data storage system of claim 18, wherein to apply the erase voltage to a block associated with the fast erase command for only a portion of the full erase duration, the controller is further configured to apply the erase voltage to the first block associated with the fast erase command until a predetermined target voltage is reached that is different than a voltage corresponding to the full erase state.

20. The data storage system of claim 18, wherein the erase voltage comprises a plurality of voltage pulses and where application of the erase pulses for less than the full erase duration comprises application of a predetermined number of erase pulses.

21. A data storage system comprising:
non-volatile memory having a plurality of blocks;
means for identifying a fast erase event and selecting a first block of the plurality of blocks for a fast erase procedure;
means for applying an erase voltage to the first block only for a period of time less than a predetermined full erase time, wherein the predetermined full erase time comprises a time duration for applying the erase voltage to bring the first block to a full erase state; and
means for applying the erase voltage to a next block of the plurality of blocks for only the period of time, after applying the erase voltage to the first block only for the period of time, and while the first block is not in the full erase state.
